(19) United States
(12) Patent Application Publication
(10) Pub. No.: US 2024/0065248 A1
(43) Pub. Date: Feb. 29, 2024

(54) PEDESTAL MOUNTED TACKLE TRAY STORAGE DEVICE

(71) Applicants: Jason Bird, Kingsley, IA (US); Thomas Edward Mongan, Cherokee, IA (US)

(72) Inventors: Jason Bird, Kingsley, IA (US); Thomas Edward Mongan, Cherokee, IA (US)

(21) Appl. No.: 18/235,545

(22) Filed: Aug. 18, 2023

Related U.S. Application Data
(60) Provisional application No. 63/400,889, filed on Aug. 25, 2022.

(51) Int. Cl. A01K 97/06; A01K 97/22

(52) U.S. Cl. CPC A01K 97/06; A01K 97/22

(57) ABSTRACT

A tackle tray storage device that can be mounted onto a pedestal chair by sliding over the top of the pedestal. The device comprises a bag with two sides, a top section, a bottom section, a front opening, and a rear opening. The device further has a top hole through the top section and a bottom hole through the bottom section of the bag to facilitate mounting onto the pedestal. Closures extend across each opening so that a plurality of tackle trays may be secured within the bag.

### CROSS-REFERENCE TO RELATED APPLICATION(S)

This application claims the benefit of U.S. Provisional Application No. 63/400,889, filed Aug. 25, 2022, and entitled “PEDESTAL MOUNTED TACKLE TRAY STORAGE DEVICE,” the disclosure of which is hereby incorporated by reference in its entirety.

### BACKGROUND

Anglers utilize tackle trays to store and organize jigs, sinkers, hooks, and other gear. Anglers often use several tackle trays to store many different items. They may also use tackle boxes to store a plurality of tackle trays. When on a boat, tackle boxes and trays are often unsecured to the boat itself. As a result, they can easily move around or become unorganized. They also present a potential tripping hazard as the angler moves within the boat. Tackle boxes and trays secured to the boat may be tedious to unsecure and transport around or off the boat.

### SUMMARY

A tackle tray storage device includes a bag with a hole in its top section and a hole in its bottom section. The holes are vertically aligned such that the holes allow the tackle tray storage device to mount onto a pedestal chair by sliding over the top of the pedestal of the chair. The tackle tray storage device further includes a closure across each opening in the bag that allows a plurality of tackle trays to be placed within the bag and secured by the closure.

### BRIEF DESCRIPTION OF THE DRAWINGS

FIG. 1 is a view of the tackle tray storage device as mounted onto the pedestal of a boat's pedestal chair.

FIG. 2 is a view of the tackle tray storage device mounted onto the pedestal of a boat's pedestal chair with a strap closure open and a user removing a tackle tray from the bag.

FIG. 3 is a view of a tackle tray storage device as a user lifts the tackle tray storage device off the pedestal by means of a handle connected to a top section of the bag.

FIG. 4 is a view of a tackle tray storage device mounted onto a pedestal of a boat's pedestal chair with a tool holder unstrapped and a user removing a pair of pliers.

FIG. 5 depicts a side view of the inside of a tackle tray storage device.

FIG. 6 is a front view of a tackle tray storage device with a flap closure closed.

FIG. 7 is a rear view of a tackle tray storage device with a flap closure closed and a pocket attached to the outside of the flap.

FIG. 8 is a front view of two tackle tray storage devices next to each other. The tackle tray storage device on the left holds four stacked tackle trays and has a closure comprising a strap with a buckle. The tackle tray storage device on the right holds three stacked tackle trays and has a closure comprising a strap with a hook and loop fastener.

FIG. 9 is a first side view of a tackle tray storage device.

FIG. 10 is a second side view of a tackle tray storage device.

### DETAILED DESCRIPTION

The tackle tray storage device disclosed herein allows an angler to store multiple tackle trays within a single bag for easy transportation. This device is further configured to allow it to mount onto the pedestal of a pedestal chair typical to fishing boats. These features provide an improvement over prior art by providing both secure storage and ease in transporting tackle trays and gear.

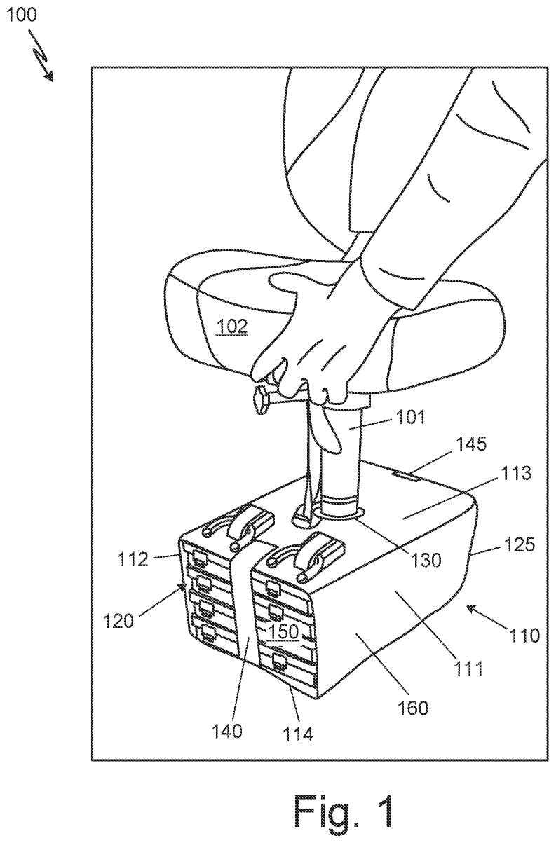

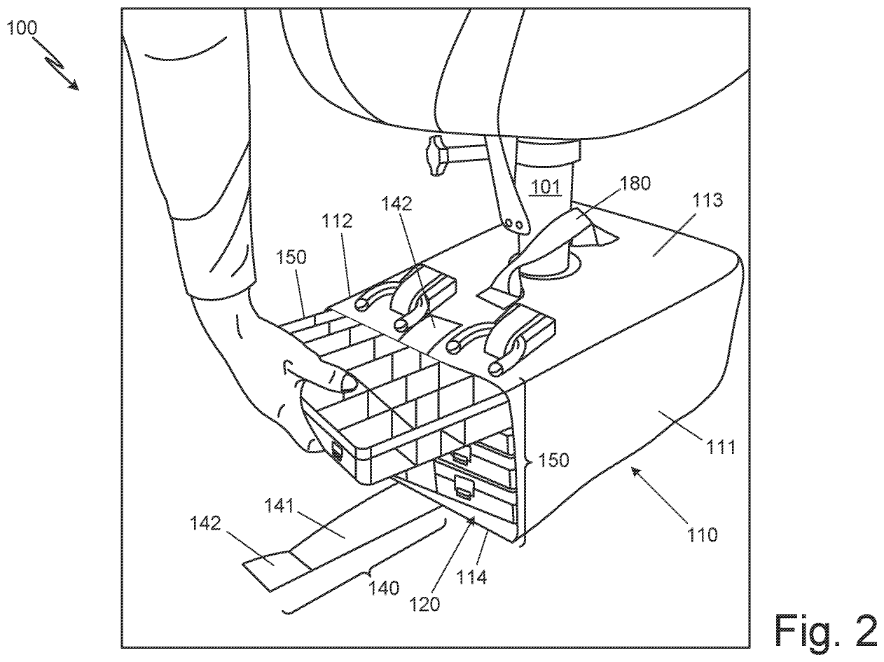

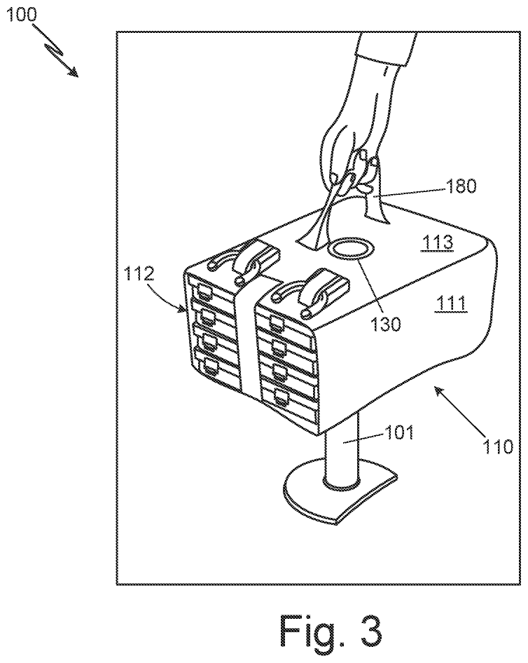

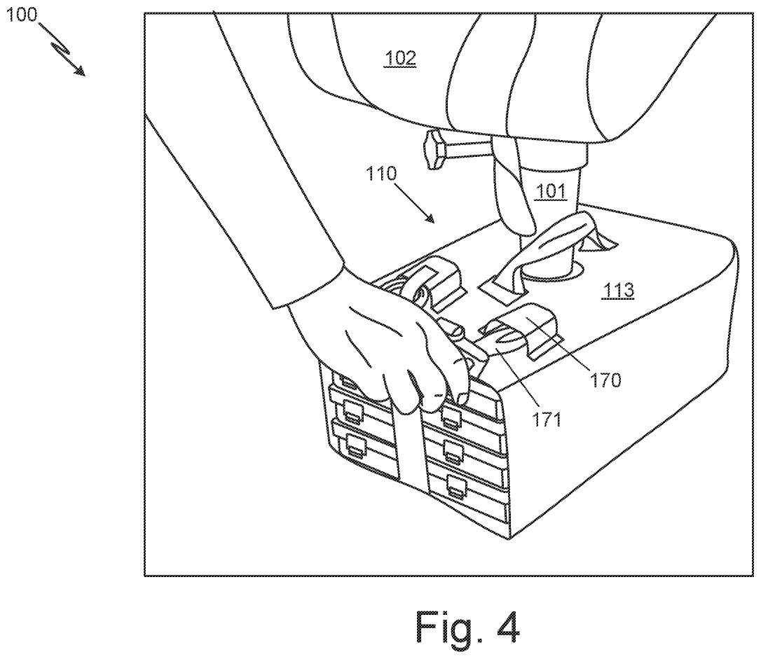

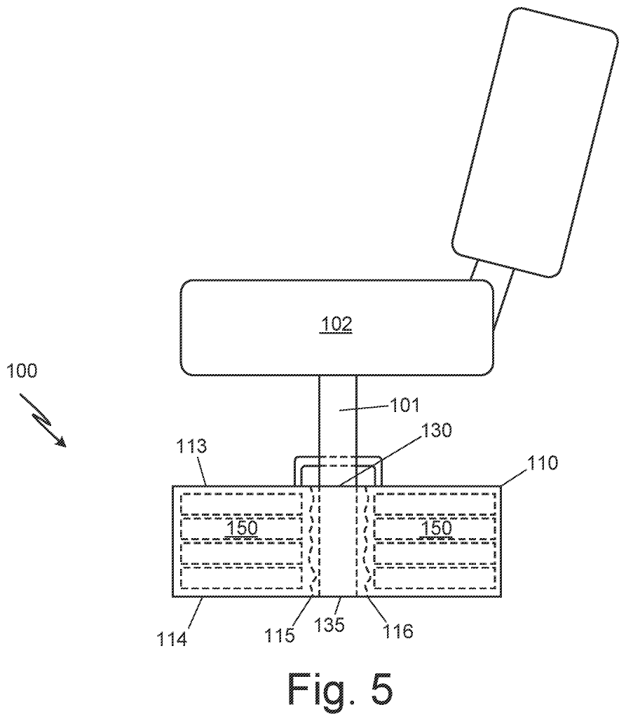

FIG. 1 is a view of tackle tray storage device 100 as mounted onto pedestal 101 of pedestal chair 102. Tackle tray storage device 100 includes bag 110, first side 111, second side 112, top section 113, bottom section 114, front layer 115 (FIG. 5), rear layer 116 (FIG. 5), front opening 120, rear opening 125, top hole 130, bottom hole 135 (FIG. 5), front closure 140, strap 141 (FIG. 2), hook and loop fastener 142 (FIG. 2), rear closure 145, pocket 160, tool holder 170 (FIG. 4), and handle 180 (FIGS. 2 and 3).

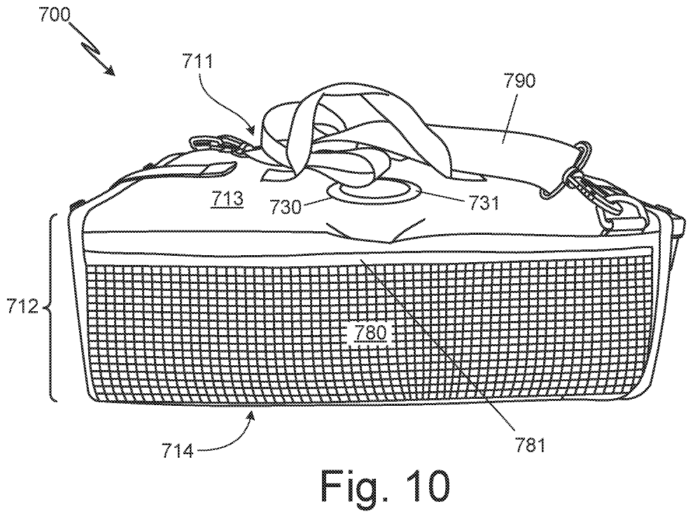

Tackle tray storage device 100 includes bag 110 with first side 111, second side 112, top section 113, bottom section 114, front opening 120, and rear opening 125. Tackle tray storage device 100 further comprises top hole 130 in top section 113 of bag 110; bottom hole 135 (FIG. 10) in bottom section 114 of bag 110; front closure 140 extending across front opening 120 of bag 110; and rear closure 145 extending across rear opening 125 of bag 110.

Bag 110 is composed of a soft-shell material such that a layer of foam is sandwiched between two layers of polyester fabric. Soft-shell material reduces the weight of tackle tray storage device 100 and allows for device 100 to be easily collapsible for storage purposes, among other benefits. Other compositions of soft-shell material such as cloth, fabric, foam, or other materials either alone or in combination may satisfy the same purpose. In alternative embodiments where these functions are not necessary, a hard-shell material may be utilized.

FIG. 2 depicts the same embodiment of tackle tray storage device 100 as FIG. 1, but further depicts that front closure 140 can open for a user to remove tackle tray 151 from bag 100. This allows the user to easily remove tackle trays 150 and gear from tackle tray storage device 100 without the need to disconnect tackle tray storage device 100 from the pedestal 101.

Front closure 140 is composed of strap 141 extending across front opening 120 of bag 110, secured permanently to bottom section 114 of bag 110, and secured to top section 113 of bag 110 by hook and loop fastener 142. A plurality of tackle trays 150 stored within bag 110 are secured by front closure 140. Alternatively, strap 141 may be permanently secured to top section 113 of bag 110 and secured to bottom section 114 of bag 110 by a hook and loop fastener or secured to both top section 113 and bottom section 114 of bag 110 by hook and loop fasteners.

FIG. 3 depicts the same embodiment as FIG. 1 but further depicts that a user can lift bag 110 off pedestal 101. The user can remove the chair seat from the top of pedestal 101 and lift tackle tray storage device 100 by handle 180 connected to top section 113 of bag 110 to dismount it from pedestal 101. This allows the user to easily remove tackle tray storage device 100 from the boat and carry the gear contained within tackle tray storage device 100 to other boats or locations without the need to unload the gear or trays 150 from tackle tray storage device 100.

FIG. 4 depicts tackle tray storage device 100 mounted onto pedestal 101 of pedestal chair 102 with a user removing pliers 171 from tool holder 170 mounted to top section 113 of bag 110. While tool holder 170 in this depiction is mounted to top section 113 of bag 110, tool holder may alternatively be attached to either side of bag 110 such as disclosed above, to a flap closure such as flap 241 disclosed above, or to another portion of the device as suitable. Tool holder 170 is configured to hold pliers such as pliers 171. The reader will understand that alternative embodiments can be configured to secure other types of tools and may be structured of other materials and in other shapes and configurations.

FIG. 5 depicts side view of tackle tray storage device 100 and the inside of device 100. Inside of bag 110, tackle trays 150 can sit freely or be separated from holes 130 and 135 and pedestal 101 of pedestal chair 102 by a layer of material such as layer 115 and layer 116. These layers can be composed of webbing, the same composition of materials constituting the other sides and sections of bag 110, or any other material capable of separating tackle trays 150 from holes 130 and 135 or pedestal 101.

FIG. 5 depicts an embodiment in which top hole 130 and bottom hole 135 are located centrally in top section 113 and bottom section 114 of the bag, respectively. In alternative embodiments, holes 130 and 135 can be located non-centrally. In alternative embodiments, holes 130 and 135 need not be circular, but can instead be of any shape capable of facilitating the ability of the tackle tray storage device 100 to mount onto the pedestal 101.

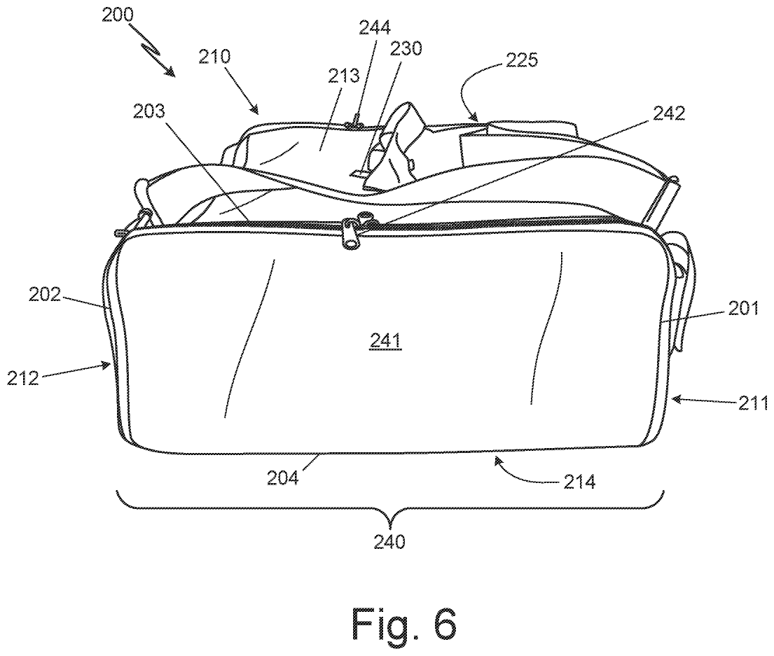

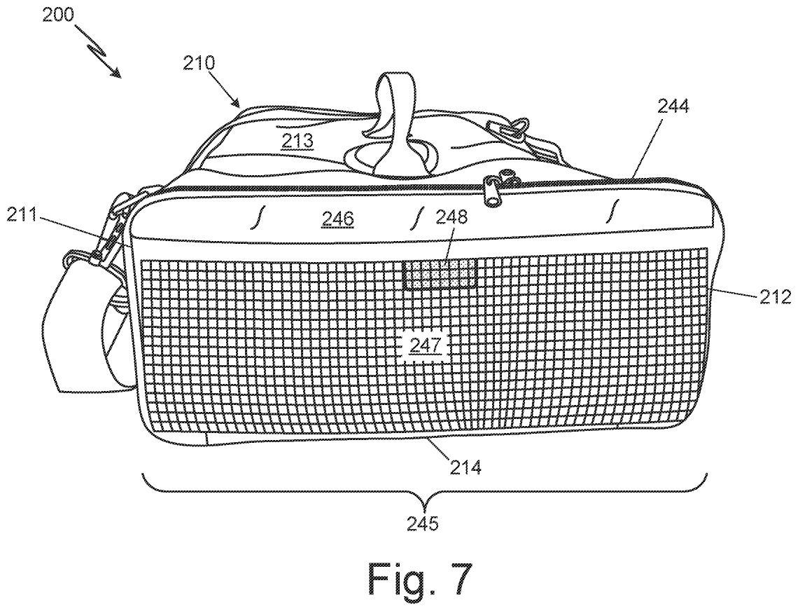

FIGS. 6 and 7 depicts a front view of tackle tray storage device 200. Tackle tray storage device 200 includes first front edge 201, second front edge 202, top front edge 203, bottom front edge 204, bag 210, first side 211, second side 212, top section 213, bottom section 214, front opening 220, rear opening 225, top hole 230, bottom hole 235, front closure 240, front closure flap 241, front closure zipper 242, rear closure zipper 244, rear closure 245, rear closure flag 246 (FIG. 7), pocket 247 (FIG. 7), and hook and loop fastener 248 (FIG. 7).

In the embodiment depicted in FIG. 6, front closure 240 comprises a flap 241 connected to front edge 204 of bottom section 214 of bag 210 and completely covering the front opening. Front closure 240 is attached to front edges 201, 202, and 203 of first side 211, second side 212, and top section 213 respectively by zipper 242. Zipper 242 can be un-zipped to allow the removal of tackle trays 150 secured within bag 210. Alternatively, flap 241 can be attached permanently to any of the other three edges 201-203 and attached by zipper 241 to remaining edges 201-204. In an alternative embodiment, zipper 242 may secure flap 241 only along any one of edges 201-204 of the opening 220 or a part of any of edges 201-204. The flap 241 can be composed of the same material as bag 210 or any other suitable material. The same style of closure or a similar one can be utilized on rear opening 225 of the bag 210.

FIG. 7 depicts the same style of closure 240 as shown in FIG. 4 but used for rear closure 245 on rear opening 225 of the bag 210. FIG. 7 further depicts that the flap style of closure can further include pocket 247 attached to the outside of flap 246 to provide further storage for the user. Pocket 247 depicted is composed of a mesh and secures to the flap by hook and loop fastener 248 at the top and center of pocket 247. However, pocket 247 should not be limited to mesh and could be composed of non-mesh fabric or any other suitable material. Pocket 247 should also not be limited to hook and loop fastener 248 as a means of securing pocket 247 closed. Pocket 247 can lack any securing mechanism or utilize any other suitable mechanism for securing closed.

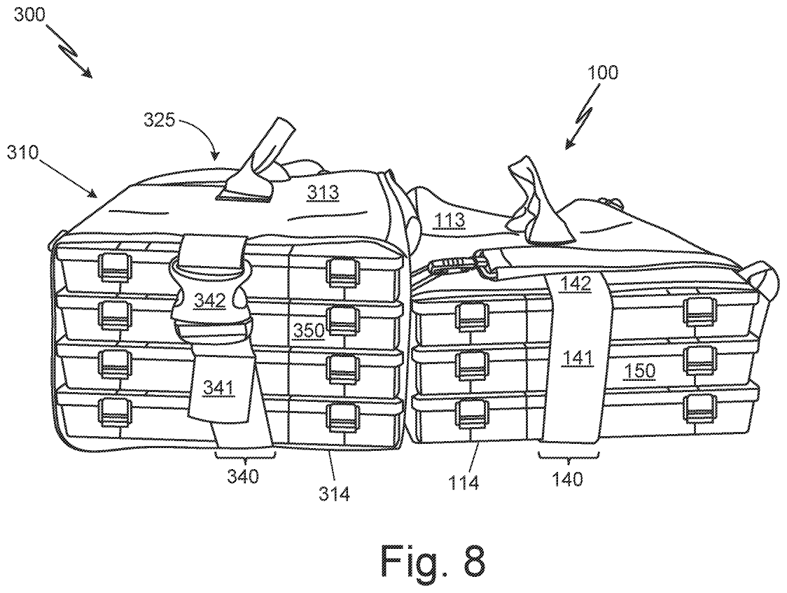

FIG. 8 depicts a front view of two tackle tray storage devices 100 and 300 of different embodiments next to each other. Tackle tray storage device 300 includes bag 310, top section 313, bottom section 314, rear opening 325, front closure 340, strap 341, and buckle 342.

Tackle tray storage device 300 on the left holds four stacked tackle trays 350 and closure 340 comprises strap 341 and buckle 342. In this embodiment, strap 341 is permanently attached to top section 313 and bottom section 314 of bag 310. Strap 341 is bisected by buckle 342 that can secure or release the plurality of tackle trays 350 within bag 310. The same style of closure or a similar one can be utilized on rear opening 325 of the bag. The tackle tray storage device on the right holds three stacked tackle trays 150. Closure 140 comprises strap 141 with hook and loop fastener 142 as disclosed previously.

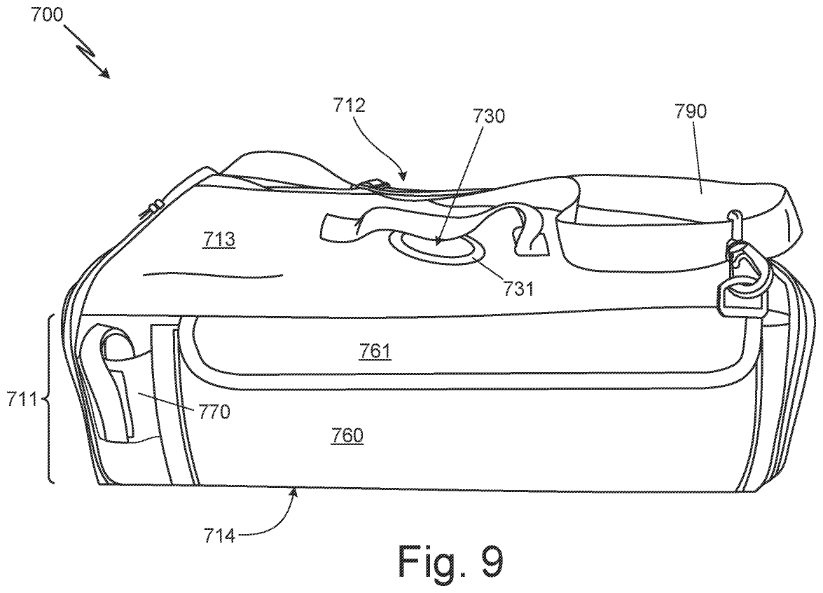

FIGS. 9 and 10 depict a first side view of tackle tray storage device 700. Tackle tray storage solution 700 includes first side 711, second side 712, top section 713, bottom section 714, top hole 730, liner 731, pocket 760, flap 761, tool holder 770, pocket 780, hook and loop fastener 781, and shoulder strap 790.

In this embodiment, the optional feature of shoulder strap 790 is attached to first side 711 and second side 712 of the bag. Alternatively, shoulder strap 790 can be attached to top section 713 or bottom section 714 of the bag. Shoulder strap 790 allows a user to carry tackle tray storage solution 700 hands-free to allow for easier transportation.

First side 711 of tackle tray storage device 700 further has pocket 760 and tool holder 770 attached. Pocket 760 is composed of a solid fabric and has flap 761 to secure pocket 760 closed. Pocket 760 can alternatively be composed of a different type of material, lack any securing mechanism, or utilize any other suitable mechanisms for securing closed. Tool holder 770 is further disclosed below.

Top hole 730 can be lined with a seal, casing, or other liner 731 to improve the durability of top section 713, fit of a pedestal within hole 730, or other benefits to their function. A similar seal, casing, or other liner can be used on the bottom hole.

FIG. 10 depicts a second side view of tackle tray storage device 700 previously depicted in FIG. 7. In FIG. 8, pocket 780 is composed of a mesh and secures to the flap by hook and loop fastener 781 at the top and center of pocket 780. However, pocket 780 should not be limited to mesh and could be composed of non-mesh piece of fabric or any other suitable material. Pocket 780 should also not be limited to hook and loop fastener 781 as a means of securing the pocket closed. Pocket 780 can lack any securing mechanism or utilize any other suitable mechanism for securing closed. Additionally, second side 712 could have multiple pockets or include attached tool holders in alternative embodiments.

While the embodiments described are geared toward tackle storage, in alternative embodiments, a tackle tray storage device as described here may function as a bag, a tote, tackle storage, a carry all, or a cooler.

While the invention has been described with reference to exemplary embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed, but that the invention will include all embodiments falling within the scope of the appended claims.

1. A tackle tray storage device comprising:
a bag comprising:
a first side;
a second side parallel to the first side;
a top section connecting the second side and the first side;
a bottom section connecting the second side and the first side opposite of the top section;
a front opening defined by front edges of the first side, the second side, the top section, and the bottom section; and
a rear opening opposite of the front opening and defined by rear edges of the first side, the second side, the top section, and the bottom section;
a top hole penetrating through the top sections of the bag;
a bottom hole penetrating through the bottom section of the bag and vertically aligned with the top hole;
a front closure extending across the front opening; and
a rear closure extending across the rear opening; and
whereby the holes are sized to allow the tackle tray storage device to mount onto a pedestal of a pedestal chair by sliding over a top of the pedestal; and
whereby the closures secure a plurality of tackle trays within the bag.

2. The tackle tray storage device of claim 1 whereby the first and second sides and the top and bottom sections of the bag are composed of a soft-shell material.

3. The tackle tray storage device of claim 2 whereby the soft-shell material is cloth, fabric, foam, or any combination thereof.

4. The tackle tray storage device of claim 2 whereby the soft-shell material is composed of a plurality of sandwiched layers of materials.

5. The tackle tray storage device of claim 1 and further comprising at least one layer of webbing separating the plurality of tackle trays from the hole penetrating through the top and bottom of the bag.

6. The tackle tray storage device of claim 1 whereby at least one of the closures comprises:
a strap connected to the top section and the bottom section across the front or rear opening and configured to attach and release from the bag by a hook and loop fastener.

7. The tackle tray storage device of claim 1 whereby at least one of the closures comprises:
a strap connected to the top section and the bottom section across the front or rear opening and configured to secure and release from the bag by a buckle bisecting the strap.

8. The tackle tray storage device of claim 1 whereby at least one of the closures comprises:
a flap connected to one side or section of the bag, extending across the front or rear opening, and configured attach and release from the edges of the other sides and sections of the bag by a zipper.

9. The tackle tray storage device of claim 8 and further comprising a pocket attached to the outside of the flap.

10. The tackle tray storage device of claim 1 and further comprising at least one pocket attached to the first side or the second side of the bag.

11. The tackle tray storage device of claim 1 and further comprising a holder for securing a tool to the bag.

12. The tackle tray storage device of claim 1 wherein the hole penetrating through the top and bottom sections of the bag is located centrally in the bag.

13. The tackle tray storage device of claim 1 and further comprising a handle connected to the top section of the bag.

14. The tackle tray storage device of claim 1 further comprising a shoulder strap that connects to the sides or sections of the bag and is configured to allow one to carry the tackle tray storage device hands-free.

15. The tackle tray storage device of claim 1 and further comprising at least one seal or casing around the top hole or the bottom hole.

16. A method of securing a plurality of tackle trays, the method comprising:
placing the plurality of tackle trays within a bag comprising:
a first side;
a second side parallel to the first side;
a top section connecting the second side and the first side;
a bottom section connecting the second side and the first side opposite of the top section;
a front opening defined by front edges of the first side, the second side, the top section, and the bottom section; and
a rear opening opposite of the front opening and defined by rear edges of the first side, the second side, the top section, and the bottom section;
securing the tackle trays within the bag by means of a closure extending across each opening;
mounting the bag onto a pedestal by inserting the pedestal through holes in the top section and the bottom section of the bag; and
mounting a seat onto the top of the pedestal.

17. The method of claim 16 whereby at least one of the closures comprises:
a strap connected to the top section and the bottom section across the front or rear opening;
whereby the strap is configured attach and release from the bag by a hook and loop fastener.

18. The method of claim 16 whereby at least one of the closures comprises:
a strap connected to the top section and the bottom section across the front or rear opening;
whereby the strap is configured with a buckle to alternatively secure or allow for the removal of the tackle trays.

19. The method of claim 16 whereby at least one of the closures comprises:
a flap connected to one side or section of the bag;
whereby the flap covers across the front or rear opening; and
whereby the strap is configured attach and release from the other sides and sections of the bag by a zipper.

20. The method of claim 16 whereby mounting the bag onto a pedestal by inserting the pedestal through a hole in the top section and the bottom section of the bag further comprises lowering the bag via a carry handle connected to the top section of the bag.

21. The method of claim 16 wherein the plurality of tackle trays are separated from the pedestal by at least one layer of webbing connected to the sides and sections of the bag.

22. The method of claim 16 wherein the sides and sections of the bag are composed of a material such as cloth, fabric, foam, or another soft-shell material or any combination thereof.
